(19) United States
(12) Patent Application Publication
(10) Pub. No.: US 2025/0106918 A1
(43) Pub. Date: Mar. 27, 2025

(54) Wireless Radio Communication Between a Wireless Communication Device and Accessory Device in an XR System

(71) Applicant: Apple Inc., CUPERTINO, CA (US)

(72) Inventors: Yilok L WONG, San Diego, CA (US); Imran LATIF, Pleasanton, CA (US)

(21) Appl. No.: 18/898,061

(22) Filed: Sep. 26, 2024

Related U.S. Application Data
(60) Provisional application No. 63/585,264, filed on Sep. 26, 2023.

(51) Int. Cl. H04W 76/14; G01S 17/66; H04W 64/00

(52) U.S. Cl. CPC H04W 76/14; G01S 17/66; H04W 64/003

(57) ABSTRACT

An apparatus comprising configured to determine a distance between the apparatus and an accessory device based on at least information collected by one or more cameras, select one or more signaling techniques to utilize for short-range communication with the accessory device based on the distance and generate a signal for transmission to the accessory device using the one or more signaling techniques.

### PRIORITY/INCORPORATION BY REFERENCE

This application claims priority to U.S. Provisional Application Ser. No. 63/585,264 filed on Sep. 26, 2023, and entitled “Wireless Radio Communication Between a Wireless Communication Device and Accessory Device in an XR System,” the entirety of which is incorporated by reference herein.

### BACKGROUND

A wireless communication device may be equipped with extended reality (XR) capabilities configured to provide a wholly or partially simulated environment that users may experience and/or interact with via the wireless communication device. For example, the wireless communication device may be a wearable device (e.g., headset, glasses, etc.) and the user may view their surrounding physical environment through the wireless communication device. When using the wireless communication device, the user may perceive virtual features as part of their physical environment. Otherwise, the virtual features are not visible to the user.

An accessory device may be configured to perform any of a variety of different functions within an XR system. The wireless communication device and the accessory device may communicate with one another using a short-range communication protocol (e.g., Bluetooth, Bluetooth Low Energy (BLE)). It has been identified that it may be beneficial for the wireless communication device to use information collected by components typically associated with XR functionality to enhance short-range communication between the wireless communication device and the accessory device in an XR system.

### SUMMARY

Some example embodiments are related to an apparatus having processing circuitry configured to determine a distance between the apparatus and an accessory device based on at least information collected by one or more cameras, select one or more signaling techniques to utilize for short-range communication with the accessory device based on the distance and generate a signal for transmission to the accessory device using the one or more signaling techniques.

Other example embodiments are related to a method for determining a distance between the apparatus and an accessory device based on at least information collected by one or more cameras, selecting one or more signaling techniques to utilize for short-range communication with the accessory device based on the distance and generating a signal for transmission to the accessory device using the one or more signaling techniques.

### BRIEF DESCRIPTION OF THE DRAWINGS

FIG. 1 shows an example arrangement according to various example embodiments.

FIG. 2 shows an example wireless communication device according to various example embodiments.

FIG. 3 shows an example deployment scenario according to various example embodiments.

FIG. 4 shows a method for wireless communication between the wireless communication device and an accessory device in an extended reality (XR) environment according to various example embodiments.

### DETAILED DESCRIPTION

The example embodiments may be further understood with reference to the following description and the related appended drawings, wherein like elements are provided with the same reference numerals. The example embodiments relate to short-range communication between a wireless communication device and an accessory device in an extended reality (XR) system.

XR is an umbrella term for different types of realities and may generally refer to real-and-virtual combined environments and associated human-machine interactions generated by computer technology and wearables. To provide some examples, the term XR may encompass augmented reality (AR), mixed reality (MR) and virtual reality (VR). Therefore, an XR environment may comprise a wholly or partially simulated environment that users may experience and/or interact with via the wireless communication device.

The example embodiments are described with regard to a wireless communication device. However, reference to a wireless communication device is merely provided for illustrative purposes. The example embodiments may be utilized with any electronic device that is configured for XR and equipped with the hardware, software, and/or firmware to wirelessly exchange signals with another device. Therefore, the wireless communication device as described herein is used represent any appropriate type of electronic device.

The example embodiments are also described with regard to an accessory device that is configured to communicate with the wireless communication device using a short-range communication protocol. Throughout this description, the term accessory device may refer to any electronic component that is equipped with the hardware, software, and/or firmware to wirelessly transmit signals to and/or receive signals from the wireless communication device. To provide one non-limiting example, the accessory device may be a low-power device that transmits information to the wireless communication device using a short-range communication protocol (e.g., Bluetooth, Bluetooth Low Energy (BLE), etc.). The wireless communication device may retrieve content for the XR environment from another source based on the information received from the accessory device and/or receive content for the XR environment directly from the accessory device. The above example is merely provided for illustrative purposes and is not intended to limit the scope of the example embodiments in any way. Additional examples of different types of accessory devices and the manner in which they may interact with the wireless communication device are provided in more detail below.

Throughout this description, the short-range communication protocol may be referred to as Bluetooth. Bluetooth (e.g., Bluetooth, Bluetooth Low-Energy (BLE), etc.) is a specific type of communication protocol that enables short-range communication between two or more devices. However, reference to Bluetooth is merely provided for illustrative purposes. The example embodiments are not limited to Bluetooth and may be implemented using any appropriate type of wireless communication protocol, e.g., Wi-Fi Direct, cellular sidelink, Zigbee, etc. Therefore, any reference to terms such as, “Bluetooth,” “BLE,” “short-range communication protocol,” “short-range connection,” or “short-range communication link” are provided for illustrative purposes and not intended to limit the example embodiments to any particular type of wireless communication protocol.

Some Bluetooth features may rely on a feedback loop. To provide a non-limiting example using the wireless communication device and the accessory device, the wireless communication device may receive a transmission from the accessory device before the wireless communication device is able to calculate and tune its radio to transmit a beam in a certain direction and/or increase power. This feedback loop has been identified as a source of latency for various Bluetooth features such as, but not limited to, power amplification and transmit beamforming.

The example embodiments introduce techniques for using information derived from wireless communication device components typically associated with XR functionality to make decisions related to short-range communication. In one aspect, the wireless communication device may use the example techniques instead of or in addition to the feedback loop to improve the latency and/or range associated with certain Bluetooth features (e.g., power amplification, transmit beamforming, etc.). In another aspect, the example techniques may be used to improve wireless communication device performance and/or the user experience associated with using the accessory device in the XR environment. Each of the example techniques are described in detail below. The example techniques introduced herein may be used independently from one another, in conjunction with other currently implemented Bluetooth and/or XR mechanisms, in conjunction with future implementations of Bluetooth and/or XR mechanisms or independently from other Bluetooth and/or XR mechanisms.

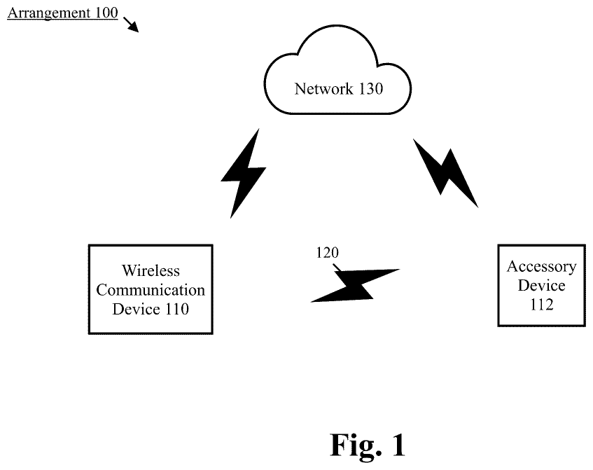

FIG. 1 shows an example arrangement 100 according to various example embodiments. The arrangement 100 includes a wireless communication device 110, an accessory device 112 and a network 130. In an actual deployment scenario, the wireless communication device 110 may communicate with multiple accessory devices and the accessory device 112 may communicate with multiple wireless communication devices. Therefore, reference to a single wireless communication device 110 and a single accessory device 112 is provided for illustrative purposes.

The network may be a sixth generation (6G) network, a fifth generation (5G) new radio (NR) network, a legacy cellular network, a wireless local area network (WLAN) or any other appropriate type of network. The wireless communication device 110 and/or the accessory device 112 may access the network 130 via an access node. Any appropriate type of association procedure may be performed for the wireless communication device 110 or the accessory device 112 to connect to the network 130 via the access node. However, the manner in which the devices connect to the network 130 is beyond the scope of the example embodiments nor do the example embodiments require either the wireless communication device 110 or the accessory device 112 to be connected to the network 130.

The wireless communication device 110 may represent any type of electronic device with XR capabilities that is configured to wirelessly communicate with another device. In various examples, the wireless communication device 110 may be referred to as a wearable device (e.g., headset, augmented reality (AR) glasses, etc.). However, the example embodiments are not limited to a wearable device and may be used with any type of device with XR capabilities that is also configured to wirelessly communicate with another device using a short-rage communication protocol.

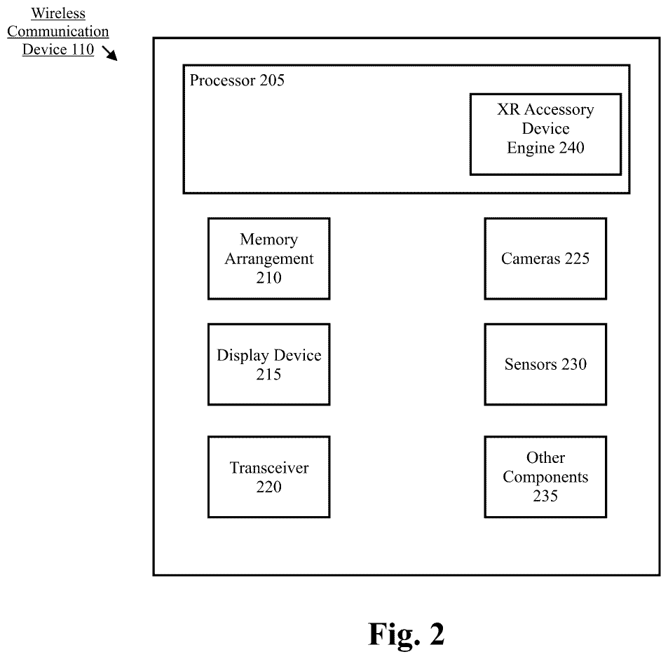

The wireless communication device 110 may be configured with various cameras and sensors to collect information about its physical environment and/or user. This information may be used to manage the visual and/or audio content presented to the user in the XR environment. In one example, the wireless communication device 110 may monitor head and/or eye movement of the user to dynamically determine how graphics and audio are to be presented to the user. In another example, the wireless communication device 110 may monitor its own orientation and movement to dynamically determine how graphics and audio are to be presented to the user. In a further example, the wireless communication device 110 may monitor for other types of physical motion by the user (e.g., hand, arm, feet, etc.) and/or audio input to dynamically determine how content is to be presented to the user. Therefore, the wireless communication device 110 may be equipped with components such as, but not limited to, microphones, cameras, light detection and ranging (LiDAR) scanners, gyroscopes and accelerometers to collect information about its physical environment and/or user. The components of the wireless communication device 110 are described in more detail below with regard to FIG. 2.

The accessory device 112 may represent any type of electronic component that is configured to communicate with another device. In various examples, the accessory device 112 may be referred to as low-power device that transmits information to the wireless communication device 110 using a short-range communication protocol. In other examples, the accessory device 112 may be a wireless communication device (e.g., smartphone, laptop computer, tablet, etc.). The information received from the accessory device 112 may include content for the XR environment and/or may enable the wireless communication device 110 to retrieve content for the XR environment from another source (e.g., network 130, another UE, a remote server, etc.). The example embodiments are not limited to any particular type of accessory device and may be used with any type of device configured to communicate with the wireless communication device 110.

The wireless communication device 110 and the accessory device 112 may communicate with one another using a short-range communication protocol (e.g., Bluetooth, BLE, etc.). Accordingly, when the wireless communication device 110 and the accessory device 112 are within a proximity of one another (e.g., within a distance in which short-range communication may be performed), the wireless communication device 110 and the accessory device 112 may exchange data over the communication link 120. In this example, the communication link 120 is bidirectional. In other examples, the communication link 120 may represent one or more unidirectional communication links between the wireless communication device 110 and the accessory device 112.

FIG. 2 shows an example wireless communication device 110 according to various example embodiments. The wireless communication device 110 will be described with regard to the arrangement 100 of FIG. 1. The wireless communication device 110 may include a processor 205, a memory arrangement 210, a display device 215, a transceiver 220, cameras 225, sensors 230 and other components 235. The other components 235 may include, for example, an external power amplifier (EPA), antenna panels each comprising one or more antenna elements, an audio output device, a power supply, a data acquisition device, ports to electrically connect the wireless communication device 110 to other electronic devices, etc.

The processor 205 may be configured to execute a plurality of engines of the wireless communication device 110. For example, the engines may include an XR accessory device engine 240. The XR accessory device engine 240 may perform various operations related to communicating with XR accessory devices using a short-range communication protocol.

The above referenced engine 240 being an application (e.g., a program) executed by the processor 205 is merely provided for illustrative purposes. The functionality associated with the engine 240 may also be represented as a separate incorporated component of the wireless communication device 110 or may be a modular component coupled to the wireless communication device 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the wireless communication device 110. The display device 215 may be a hardware component configured to show a partially or wholly simulated environment to the user.

The transceiver 220 may be a hardware component configured to wirelessly transmit and/or receive data. Thus, the transceiver 220 may enable communication with other electronic devices directly (e.g., Bluetooth, BLE, etc.) or indirectly through the network 130 (e.g., 6G, 5G, legacy cellular network, WLAN, etc.). Accordingly, the transceiver 220 may comprise one or more different types of radios that operate on a variety of different frequencies or channels (e.g., set of consecutive frequencies). The transceiver 220 may also include or be communicatively coupled to multiple antennas configured for beamforming. The transceiver 220 includes circuitry configured to transmit and/or receive signals (e.g., control signals, data signals). Such signals may be encoded with information implementing any one of the methods described herein. The processor 205 may be operably coupled to the transceiver 220 and configured to receive from and/or transmit signals to the transceiver 220. The processor 205 may be configured to encode and/or decode signals (e.g., signaling from an access point of a network) for implementing any one of the methods described herein.

The cameras 225 may comprise multiple different types of cameras (e.g., visible light cameras, infrared cameras, etc.) located at different positions on the wireless communication device 110. One or more cameras may capture images and other information of the physical environment around the wireless communication device 110 and one or more cameras may capture images and other information of the user, e.g., head movement, eye movement, arm movement, hand movement, etc. Therefore, cameras 225 represents any appropriate number and/or type of camera.

The sensors 230 may comprise various different types of sensors located at different positions on the wireless communication device 110. The sensors 230 may obtain information about the physical environment around the wireless communication device 110, the movement of the wireless communication device 110 and/or the movement of the user. The sensors 230 may include, but are not limited to, image sensors, microphones, temperature sensors, LiDAR sensors, radar, sonar, GPS sensors, gyroscopes, infrared sensors and/or any other type of sensor. Therefore, sensors 230 represents any appropriate number and/or type of sensor.

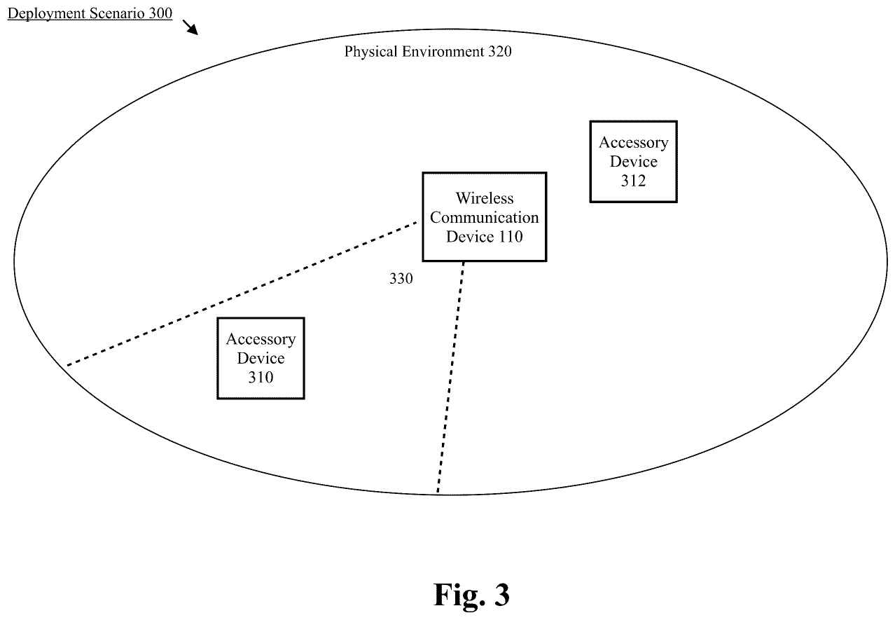

FIG. 3 shows an example deployment scenario 300 according to various example embodiments. The deployment scenario 300 includes the wireless communication device 110 and accessory devices 310, 312.

The example deployment scenario 300 illustrates the wireless communication device 110 and the accessory device 310, 312 deployed within a physical environment 320. The physical environment 320 may represent any appropriate type of real-world location. To provide some non-limiting examples, the physical environment 320 may be a room in a house, an office in a workplace, a backyard, a field in a park or a cabin of a vehicle. Although not shown in the deployment scenario 300, the physical environment may include physical surfaces and physical objects (e.g., items, people, animals, etc.).

In some examples, the wireless communication device 110 may be a wearable device (e.g., headset, etc.) with XR capabilities. In some scenarios, the wireless communication device 110 may generate a partially simulated environment that allows the user to view and/or interact with virtual objects that appear to be integrated with the physical environment 320. In other scenarios, the wireless communication device 110 may generate a wholly simulated environment that does not appear to include any aspects of the physical environment 320.

The accessory devices 310, 312 may perform any of a variety of different functions for the wireless communication device 110. For example, the wireless communication device may retrieve content for the XR environment from another source based on the information received from the accessory devices 310, 312 and/or receive content for the XR environment directly from the accessory devices 310, 312. In some embodiments, compared to a wireless communication device, an accessory device may be a low-power device with reduced capabilities. In other embodiments, the accessory device may be another wireless communication device (e.g., smartphone, laptop, tablet, etc.). However, the example embodiments are not limited to any particular type of accessory device nor are the example embodiments limited to an accessory device that directly or indirectly provides content to the wireless communication device 110. The particular function of the accessory device with regard to XR is beyond the scope of the example embodiments. The example embodiments relate to the signaling between the wireless communication device 110 and an accessory device using the short-range communication protocol. Therefore, the accessory devices 310, 312 may represent any appropriate type of electronic component configured to communicate with the wireless communication device 110 using the short-range communication protocol.

In the example deployment scenario 300, it may be considered that the wireless communication device 110 is being held or worn by the user. Within the physical environment 320, the user is facing the direction of the accessory device 310 and the accessory device 312 is located behind the user. The field of view of the user 330 is illustrated in FIG. 3 as dotted lines. Thus, the accessory device 310 is within the field of view of the user 330 and the accessory device 312 is not within the field of view of the user 330. As will be described in more detail below, in some embodiments, the wireless communication device 110 may determine that the user intends to utilize an accessory device based on the direction the user is facing and/or eye tracking. In this example, the wireless communication device 110 may determine that the user intends to use the accessory device 310 because it is within the field of view of the user 330.

As mentioned above, in some scenarios, certain Bluetooth features may rely on a feedback loop. To provide an example within the context of the example deployment scenario 300, the wireless communication device 110 may receive a signal from the accessory device 310 and based on the received signal, the wireless communication device 110 may tune its transceiver 220 to transmit a signal to the accessory device 310 using a beam aimed in a particular direction and/or increase power. Without the signal from the accessory device 310, the wireless communication device 110 may not know the direction in which to transmit a beam to the accessory device 310 and/or an adequate transmit power. As will be described in more detail below, the example embodiments introduce techniques that may be used instead of or in addition to this type of feedback loop.

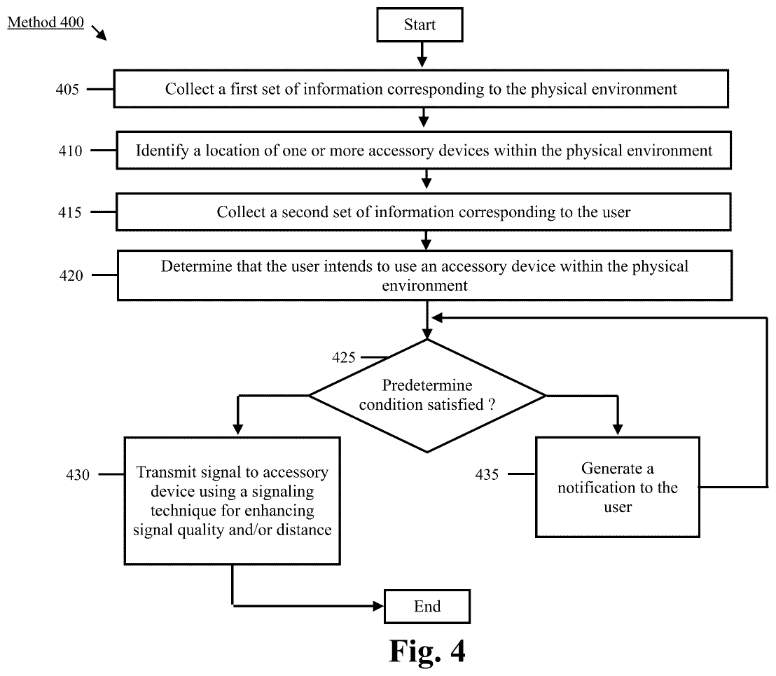

FIG. 4 shows a method 400 for wireless communication between the wireless communication device and an accessory device in an XR environment according to various example embodiments. The method 400 is described from the perspective of the wireless communication device 110 within the context of the example deployment scenario 300 of FIG. 3.

In 405, the wireless communication device 110 collects a first set of information corresponding to the physical environment. The first set of information may include data collected using the cameras 225 and sensors 230 that may be used to describe or map the physical environment 320. For example, the first set of information may include measurement data corresponding to the size and/or shape of physical objects in the physical environment 320, the distance between the wireless communication device 110 and the physical objects, the distance between the wireless communication device 110 and a point on the user, the size and/or shape of physical surfaces in the physical environment 320 and the distance between the wireless communication device 110 and the physical surfaces.

The collection of the first set of information may be a continuous process. Once initial data is collected, objects may be tracked in the physical environment 320. The object tracking data may be used to update the first set of information. In addition, the cameras 225 and sensors 230 may continue to monitor the physical environment 320 for new objects and conditions.

In some embodiments, the wireless communication device 110 may generate a virtual representation of the physical environment 320 for mapping and tracking operations. The virtual representation may include a coordinate system or any other appropriate type of mechanism to indicate the position of objects within the physical environment 320. Therefore, the first set of information may include one or more coordinates for objects within the physical environment 320. In addition, the first set of information may include global positioning system (GPS) data corresponding to the physical environment 320 and/or the objects within the physical environment 320 for mapping and tracking operations.

In some example embodiments, the wireless communication device 110 may use computer vision techniques and tag objects for mapping and tracking operations. The above examples are merely provided for illustrative purposes, the example embodiments are not required to use any particular approach to collect the first set of information.

The first set of information may further include data provided to the wireless communication device 110 by another device. For example, the wireless communication device 110 may receive data from another device directly over a short-range communication link or indirectly from the network 130. This data may include measurement data or any other appropriate type of data that may be used to describe or map the physical environment 320.

In 410, the wireless communication device 110 identifies a location of one or more accessory devices within the physical environment 320 based on the first set of information. For example, the wireless communication device 110 may identify the location of the accessory device 310 and accessory device 312 within the physical environment 320.

In some examples, the wireless communication device 110 may identify the location of an accessory device within the physical environment 320 using information received from the accessory device or another device directly over the air or indirectly via the network 130. Once identified, the location of the accessory device may be tracked using the cameras 225 and/or sensors 230.

In other examples, the wireless communication device 110 may identify accessory devices within the physical environment 320 using information collected by the cameras 225 and sensors 230. In one example, an accessory device may be physically tagged with an identifier that is visible to the human eye or non-visible to the human eye (e.g., infrared, etc.). The wireless communication device 110 may monitor for the identifier when collecting the first set of information in 405 using the cameras 225 and sensors 230. In another example, an accessory device may be identified based one or more physical features (e.g., size, shape, orientation, etc.). The wireless communication device 110 may monitor for certain physical features when collecting the first set of information in 405 using the cameras 225 and sensors 230. The above examples are not intended to limit the example embodiments in any way. The wireless communication device 110 may identify an accessory device within the physical environment 320 using any appropriate techniques.

In 415, the wireless communication device 110 collects a second set of information corresponding to the user. The second set of information may include data collected using the cameras 225 and sensors 230. For example, the second set of information may include, but is not limited to, data related to the mobility of the user within the physical environment 320, data related to the pose of the user, data related to the movement of the user (e.g., hand gestures, arm movement, leg movement, etc.), data related to the head movement of the user and data related to the eye location and/or movement of the user.

In 420, the wireless communication device 110 determines that the user intends to use an accessory device located within the physical environment 320. The wireless communication device 110 may make this determination based on the first set of information and the second set of information.

In some embodiments, eye tracking data may indicate that the user is looking at one of the accessory devices. To provide an example within the context of the example deployment scenario 300, the user may be wearing the wireless communication device 110 and looking at the accessory device 310. The wireless communication device 110 may determine that the user is looking at accessory device 310. This may indicate to the wireless communication device 110 that the user intends to use the accessory device 310. In other embodiments, instead of or in addition to the eye tracking data, the wireless communication device 110 may determine that the user intends to use the accessory device 310 based on vocal commands, hand gestures, user input, a state of the accessory device (e.g., open, closed, clamshell mode, activated, deactivated, etc.), proximity to the accessory device 310, a time of day, a day of the week and conditions present during previous interactions between the wireless communication device 110 and the accessory device. The above examples are not intended to limit the example embodiments in any way. The example embodiments may use any appropriate type of one or more conditions to determine that the user intends to user a particular accessory device.

In 425, the wireless communication device 110 determines whether a predetermined condition is satisfied. The predetermined condition may indicate that the wireless communication device 110 may successfully utilize certain features supported by the short-range communication protocol to signal the accessory device the user intends to use in the XR environment. The features may include techniques for enhancing signal quality and/or a distance at which the wireless communication device 110 can communicate with another device. The example features may include, but are not limited to, power amplification and transmit beamforming. As described above, typically, these features would require the wireless communication device 110 to receive a signal from the accessory device. In this example, instead of relying on feedback, the wireless communication device 110 may know the direction at which to transmit a beam or an adequate transmit power to be utilized based on the first set of information and the second set of information.

In 425, if the predetermined condition is satisfied, the method 400 continues to 430. In 430, the wireless communication device 110 transmits a signal to an accessory device using a signaling technique for enhancing signal quality and/or a distance at which the wireless communication device 110 can communicate with another device (e.g., transmit beamforming, power amplification, etc.). Therefore, the wireless communication device 110 is able to use these features without feedback from the other device.

To provide an example within the context of the deployment scenario 300, the field of view of the user 330 may indicate to the wireless communication device 110 that the user intends to use the accessory device 310. The wireless communication device 110 may derive various different types of measurements from the physical environment 320 based on the first set of information and the second set of information. In this example, the measurement may correspond to the accessory device 310. The measurements may be compared to predetermined thresholds configured to indicate whether certain Bluetooth features should be utilized.

One example threshold may be based on a distance between the wireless communication device 110 and an accessory device. For example, the wireless communication device 110 may derive a value for a distance parameter that is based on an angle between the wireless communication device 110 and the accessory device 310 and/or a distance measurement between the wireless communication device 110 and the accessory device 310 based on a LiDAR sensor of the wireless communication device 110. When the value of the distance parameter is above a threshold value, the distance between the wireless communication device 110 and the accessory device may necessitate power amplification (e.g., EPA or any other appropriate power amplification technique) and/or transmit beamforming. Typically, the wireless communication device 110 would rely on feedback from the accessory device 310 to use these features. Since the example techniques do not rely on feedback, the latency typically associated with activating certain Bluetooth features (e.g., power amplification, transmit beamforming, etc.) may be improved. The above examples re merely provided for illustrative purposes and are not intended to limit the example embodiments in any way, the example embodiments may be use any appropriate type of one conditions to activate any type of Bluetooth feature without receiving feedback from the accessory device.

Returning to 425, if the predetermined condition is not satisfied, the method 400 continues to 435. This may indicate that the wireless communication device 110 is unlikely to be able to successfully use the example techniques for enhancing signal quality and/or distance at which the wireless communication device 110 can communicate with another device.

In 435, the wireless communication device 110 generates a notification to the user. In one example, the notification may instruct the user to move closer to the accessory device the user intends to utilize. For instance, the wireless communication device 110 may limit transmissions to accessory devices to within a predetermined distance of the accessory device. The notification may direct the user to a location within the predetermined distance from the accessory device. In another example, the notification may instruct the user to confirm their intention to interact with the accessory device via user input (e.g., vocal command, hand gesture, etc.). The notification may be a graphic, text-based, audio-based or any combination thereof. The method 400 then returns to 425 of the method 400 where the wireless communication device 110 determines whether the predetermined condition is satisfied.

The notification in 435 may enable the wireless communication device 110 to control the distance at which the wireless communication device 110 is triggered to attempt to communicate with an accessory device. In one aspect, this may improve the user experience associated with the wireless communication device 110 and its accessory devices because it makes the user aware of the actions needed to take to acquire content from the desired accessory device or use the accessory device in some other manner.

The example embodiments may extend that range of the wireless communication device 110 with regard to the short-range communication protocol. To provide an example within the context of the example deployment scenario 300, under some circumstances, the wireless communication device 110 may require a packet to be received from the accessory device 310 before the wireless communication device 110 is able to use Bluetooth features such as, but not limited to, power amplification and transmit beamforming. Under these conditions, if the wireless communication device 110 is out of range of the accessory device 310, communication may be unable to occur because features like power amplification and transmit beamforming cannot be used without receiving packet from the accessory device 310. In contrast, the example embodiments use components typically associated with XR to identify the location of the accessory device 310 within the physical environment 320. The wireless communication device 110 then determines that power amplification and/or transmit beamforming may be needed to signal the accessory device 310 based on its location relative to the wireless communication device 110. The wireless communication device 110 may transmit a beam in the direction of the accessory device 310 using an adequate transmit power based on the information collected by the cameras 225 and sensors 230 of the wireless communication device 110 without receiving a packet from the accessory device 310.

As described above, the transmit range of the wireless communication device 110 may be extended because techniques such as, but not limited to, power amplification and transmit beamforming may be performed without receiving a signal from the accessory device 310. However, in some scenarios, the wireless communication device 110 may be outside of the range with which the accessory device 310 can successfully deliver an acknowledgement. For example, the wireless communication device 110 may boost its own transmit power to send a signal that reaches the accessory device 310 but wireless communication device 110 may be outside of the wireless range of the accessory device 310 and thus, may not be able to receive an acknowledgement in response to the transmitted signal to know whether or not the transmission was successfully received by the accessory device 310. If the wireless communication device 110 does not receive an acknowledgement the wireless communication device 110 may not know when to terminate its communication attempts towards the accessory device 310.

According to some aspects, the example embodiments introduce techniques for extending the range of the accessory device 310 acknowledgement path. In some embodiments, instead of or in addition to transmitting an acknowledgment over the air, the accessory device 310 may use a visual indication to acknowledge the reception of a transmission from the wireless communication device 110. For example, the wireless communication device 110 may send a signal to the accessory device 310. The accessory device 310 may turn on one or more light emitting diode (LEDs) to acknowledge that the signal was successfully received. The wireless communication device 110 may identify the visual indication provided by the accessory device 310 using its camera 225 and/or sensors 230. However, reference to an LED is merely provided for illustrative purposes. The accessory device 310 may use any appropriate type of one or more components to generate a visual indication for the wireless communication device 110. To provide some non-limiting examples, the accessory device 310 may use a particular color light, a lighting element other than LED, a visual indication such as infrared that is not visible to the human eye or a type of physical motion to provide a visual indication that acknowledges successful reception of a signal from the wireless communication device 110. Thus, the example embodiments may utilize any appropriate type of change to its visual or physical state as an acknowledgement.

### EXAMPLES

In a first example, a method, comprising determining a distance between the wireless communication device and an accessory device based on at least information collected by one or more cameras of the UE, selecting one or more signaling techniques to utilize for short-range communication with the accessory device based on the distance and generating a signal for transmission to the accessory device using the one or more signaling techniques.

In a second example, the method of the first example, wherein the accessory device is configured to perform functions for extended reality (XR).

In a third example, the method of the first example, wherein the information collected by the one or more cameras comprises eye tracking data.

In a fourth example, the method of the first example, wherein determining the distance between the wireless communication device and the accessory device is further based on light detection and ranging (LiDAR) data collected by a LiDAR sensor of the UE.

In a fifth example, the method of the first example, wherein the one or more signaling techniques include transmit beamforming.

In a sixth example, the method of the first example, wherein the one or more signaling techniques include power amplification using an external power amplifier (EPA).

In a seventh example, the method of the first example, wherein the one or more signaling techniques include power amplification.

In an eighth example, the method of the first example, wherein selecting the one or more signaling techniques is performed without receiving a packet from the accessory device.

In a ninth example, the method of the first example, further comprising generating a notification instructing a user to move within a predetermined distance of the accessory device.

In a tenth example, the method of the ninth example, wherein the transmission is limited to the accessory device within the predetermined distance.

In an eleventh second example, the method of the first example, further comprising identifying a visual indication provided by the accessory device that is configured to acknowledge successful reception of the signal.

In a twelfth example, the method of the eleventh example, wherein the visual indication is a visual or physical state change of the accessory device.

In a thirteenth example, the method of the eleventh example, wherein the visual indication is based on a light emitting diode (LED) of the accessory device.

In a fourteenth example, a processor configured to perform any of the methods of the first through thirteenth examples.

In a fifteenth example, a wireless communication device configured to perform any of the methods of the first through thirteenth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
determine a distance between the apparatus and an accessory device based on at least information collected by one or more cameras;
select one or more signaling techniques to utilize for short-range communication with the accessory device based on the distance; and
generate a signal for transmission to the accessory device using the one or more signaling techniques.

2. The apparatus of claim 1, wherein the accessory device is configured to perform functions for extended reality (XR).

3. The apparatus of claim 1, wherein the information collected by the one or more cameras comprises eye tracking data.

4. The apparatus of claim 1, wherein determining the distance between the apparatus and the accessory device is further based on light detection and ranging (LiDAR) data collected by a LiDAR sensor.

5. The apparatus of claim 1, wherein the one or more signaling techniques include transmit beamforming.

6. The apparatus of claim 1, wherein the one or more signaling techniques include power amplification using an external power amplifier (EPA).

7. The apparatus of claim 1, wherein the one or more signaling techniques include power amplification.

8. The apparatus of claim 1, wherein selecting the one or more signaling techniques is performed without receiving a packet from the accessory device.

9. The apparatus of claim 1, wherein the processing circuitry is further configured to:
generate a notification instructing a user to move within a predetermined distance of the accessory device.

10. The apparatus of claim 9, wherein the transmission to the accessory device is limited to within the predetermined distance.

11. The apparatus of claim 1, wherein the processing circuitry is further configured to:
identify a visual indication provided by the accessory device that is configured to acknowledge successful reception of the signal.

12. The apparatus of claim 11, wherein the visual indication is a visual or physical state change of the accessory device.

13. The apparatus of claim 11, wherein the visual indication is based on a light emitting diode (LED) of the accessory device.

14. The apparatus of claim 1, wherein the apparatus comprises a wireless communication device.

15. A method, comprising:
determining a distance between the apparatus and an accessory device based on at least information collected by one or more cameras;
selecting one or more signaling techniques to utilize for short-range communication with the accessory device based on the distance; and
generating a signal for transmission to the accessory device using the one or more signaling techniques.

16. The method of claim 15, wherein the accessory device is configured to perform functions for extended reality (XR).

17. The method of claim 15, wherein the information collected by the one or more cameras comprises eye tracking data.

18. The method of claim 15, wherein determining the distance between the apparatus and the accessory device is further based on light detection and ranging (LiDAR) data collected by a LiDAR sensor.

19. The method of claim 15, wherein the one or more signaling techniques include one of transmit beamforming, power amplification using an external power amplifier (EPA) or power amplification.

20. The method of claim 15, wherein selecting the one or more signaling techniques is performed without receiving a packet from the accessory device.
